(19) United States
(12) Patent Application Publication
(10) Pub. No.: US 2026/0220858 A1
(43) Pub. Date: Jul. 30, 2026

(54) IMAGE PRESENT METHOD AND APPARATUS, ELECTRONIC DEVICE, AND STORAGE MEDIUM

(71) Applicant: Beijing Zitiao Network Technology Co., Ltd., Beijing (CN)

(72) Inventors: Qi LI, Beijing (CN); Nan ZHAO, Beijing (CN)

(21) Appl. No.: 18/722,533

(22) PCT Filed: Dec. 16, 2022
(86) PCT No.: PCT/CN2022/139519

§ 371 Date: Jun. 20, 2024

(30) Foreign Application Priority Data
Dec. 20, 2021 (CN) 202111566791.0

(51) Int. Cl. G06T 13/00; G06T 11/60

(52) U.S. Cl. CPC G06T 13/00; G06T 11/60; G06T 2200/24; G06T 2210/21

(57) ABSTRACT

Embodiments of the disclosure provide an image present method and apparatus, an electronic device, and a storage medium. The method includes: dynamically presenting, in response to an effect trigger operation, a plurality of first present elements according to a preset present mode; displaying, in response to relative present information between at least one first present element and a main element being a persistence presentation, the at least one first present element on the main element; and continuing to dynamically present, according to the preset present mode, the first present element having relative present information with the main element being a non-persistence presentation.

The disclosure claims priority to Chinese Patent Application No. “202111566791.0”, filed with China National Intellectual Property Administration on Dec. 20, 2021, the disclosure of which is incorporated herein by reference in its entirety.

### FIELD

Embodiments of the disclosure relate to the technical field of image processing, and for example, relate to an image present method and apparatus, an electronic device, and a storage medium.

### BACKGROUND

With the development of network technology, more and more applications have been applied to lives of users, especially a series of software that may shoot short videos, which are deeply loved by the users.

In order to improve the richness and interest of video shooting content, software developers may develop a variety of effect props, such that the users may shoot a variety of videos based on the effect props.

However, the interactivity between the effect props and the users in the related art is poor, and the videos shot based on the effect props have certain limitations, leading to the problem of a poor video shooting effect.

### SUMMARY

The disclosure provides an image present method and apparatus, an electronic device, and a storage medium, so as to achieve the technical effects of improving the richness of video content and interactivity between meteorological effects and users.

In a first aspect, an embodiment of the disclosure provides an image present method. The method includes: dynamically presenting, in response to an effect trigger operation, a plurality of first present elements according to a preset present mode; displaying, in response to relative present information between at least one first present element and a main element being a persistence presentation, the at least one first present element on the main element; and continuing to dynamically present, according to the preset present mode, the first present element having relative present information with the main element being a non-persistence presentation.

In a second aspect, an embodiment of the disclosure provides an image present apparatus. The apparatus includes: an element present module, configured to dynamically present, in response to an effect trigger operation, a plurality of first present elements according to a preset present mode; and a first present module, configured to display, in response to relative present information between at least one first present element and a main element being a persistence presentation, the at least one first present element on the main element; and continue to dynamically present, according to the preset present mode, the first present element having relative present information with the main element being a non-persistence presentation.

In a third aspect, an embodiment of the disclosure further provides an electronic device. The electronic device includes: a processor; and a storage means, configured to store a program. When the program is executed by the processor, the processor implements the image present method according to any one of the embodiments of the disclosure.

In a fourth aspect, an embodiment of the disclosure further provides a storage medium including computer executable instructions. The computer executable instructions, when executed by a computer processor, are configured to execute the image present method according to any one of the embodiments of the disclosure.

### BRIEF DESCRIPTION OF THE DRAWINGS

FIG. 1 is a schematic flowchart of an image present method according to Embodiment 1 of the disclosure;

FIG. 2 is a schematic diagram of an effect of snowflakes falling on eyelashes according to Embodiment 1 of the disclosure;

FIG. 3 is a schematic flowchart of an image present method according to Embodiment 2 of the disclosure;

FIG. 4 is a schematic diagram of facial key points according to Embodiment 2 of the disclosure;

FIG. 5 is a schematic diagram of relative positions between snowflake particles and a line collision body according to Embodiment 2 of the disclosure;

FIG. 6 is a schematic flowchart of an image present method according to Embodiment 3 of the disclosure;

FIG. 7 is a schematic flowchart of an image present method according to Embodiment 4 of the disclosure;

FIG. 8 is a structural schematic diagram of an image present apparatus according to Embodiment 5 of the disclosure; and

FIG. 9 is a structural schematic diagram of an electronic device according to Embodiment 6 of the disclosure.

### DETAILED DESCRIPTION OF EMBODIMENTS

Embodiments of the disclosure will be described with reference to the accompanying drawings below. Although the accompanying drawings show some embodiments of the disclosure, it should be understood that the disclosure may be implemented in various forms, and these embodiments are provided for a more thorough and complete understanding of the disclosure. It should be understood that the accompanying drawings and the embodiments of the disclosure are for exemplary purposes only.

It should be understood that the steps recorded in the method implementations in the disclosure may be performed in different orders and/or in parallel. In addition, the method implementations may include additional steps and/or omit the execution of the shown steps.

The term “including” and variations thereof used in this specification are open-ended, namely “including but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. The related definitions of other terms will be provided in the subsequent description.

It should be noted that “first,” “second,” and other concepts mentioned in the disclosure are only for distinguishing different apparatuses, modules, or units. It should be noted that modifications such as “a” and “a plurality of” mentioned in the disclosure are indicative, and those skilled in the art should understand that unless otherwise explicitly specified in the context, it should be interpreted as “one or more”.

The names of messages or information exchanged between multiple apparatuses in the implementations of the disclosure are provided for illustrative purposes only.

Before introducing specific implementations, application scenarios may be first exemplarily described. This embodiment may be applied to any view needing effect displays, such as a short video shooting scenario, or any other video shooting scenarios.

A first present element may be any element that may be scattered and displayed on a display interface. In this embodiment, added effects simulate snowflakes, raindrops, or hail in a real environment, which are effects that fall on a main element. The main element may be any part of a video shooting frame, or a part that may produce action changes. Optionally, it may be at least one part of a user body or an animal body, such as any position on face parts or limbs and torso. In this case, it should be understood that as long as the display interface includes the above-mentioned main element, the method in the disclosure may be adopted to determine relative present information between the first present element and the main element so as to determine whether a stacked display is needed, thereby achieving the effect of stacking the first present element in the real environment. To clearly understand main elements displayed with the stacked first present element, the main elements may be enumerated here. Optionally, the first present element indicates snowflakes, and the main elements are the tip of the nose, eyes, forehead, chin, shoulders, wrists, etc. That is, on the display interface, the snowflakes may fall on the tip of the nose, the eyelashes of the eyes, etc.

In this embodiment of the disclosure, an algorithm for implementing the prop may be deployed on a terminal device. When the first present element needs to fall on the face of the user, face recognition may be performed on a collected image based on a facial key point detection algorithm, thereby determining the main element. Further, by executing the technical solution provided by this embodiment of the disclosure, the first present element, such as the snowflakes fall from the top of a display screen to achieve an effect of stacking the snowflakes on the eyelashes. For a specific implementation, reference may be made to the following detailed descriptions.

### Embodiment 1

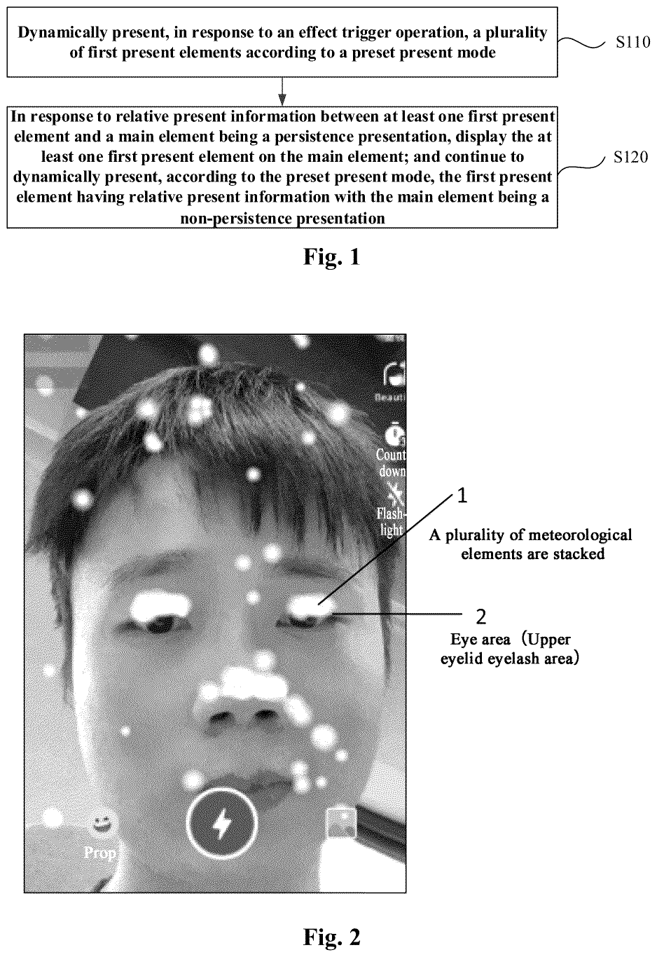

FIG. 1 is a schematic flowchart of an image present method according to Embodiment 1 of the disclosure. This embodiment of the disclosure is applicable to any effect display or effect processing scenario supported by the Internet, and is used in the case that first present elements are stacked to be displayed according to relative present information between the first present elements and a main element in the process of displaying a meteorological effect, thereby simulating a real scenario. The method may be executed by an image present apparatus. The apparatus may be implemented in the form of software and/or hardware, and optionally, implemented by an electronic device. The electronic device may be a mobile terminal, a personal computer (PC) terminal, a server, etc.

As shown in FIG. 1, the method includes the following:

S110: in response to an effect trigger operation, a plurality of first present elements are dynamically presented according to a preset present mode.

In this embodiment, an apparatus for executing the image present method provided by this embodiment of the disclosure may be integrated into application software supporting an image processing function. The software may be installed in an electronic device. Optionally, the electronic device may be a mobile terminal, or a PC terminal, etc. The application software may be a type of software for image/video processing. Specific application software is only required for achieving image/video processing. The application software may also be software with a specifically developed application to achieve the addition and display of effects, or it may be integrated into a corresponding page, and the user may achieve effect addition processing through the integrated page in the PC terminal.

In this embodiment, the first present element may be understood as a weather element in a natural environment. For example, the first present element may include at least one of a snowflake element, a water droplet element, and a hail element. After an effect prop is triggered, the first present elements may be dynamically presented on the display interface, thereby presenting a display effect of the first present elements in the real environment. For example, dynamic display may adopt a corresponding algorithm to simulate snowfall or rainfall in the real scenario, and the snowfall or rainfall is presented on the terminal device. A predefined present mode of each first present element on the display interface is determined as the preset present mode. The display of the first present element is mostly based on a material point method (MPM) to construct a meteorological simulation effect.

In this embodiment, the method further includes: a preset present mode is determined. Optionally, the step of determining a preset present mode includes the following: the preset present mode is determined based on at least two of a preset initial position, initial velocity, and gravity information of each first present element.

In this embodiment, the initial position may be an initial descending position of the first present element, which may be an upper edge of the display interface or any position in a virtual space. After descending from any position, the first present element may land on the display interface. The initial velocity may be an initial falling velocity of the first present element. Optionally, the initial falling velocity may be 0 m/s or have a certain velocity value. Certain gravity values may be assigned to the first present elements in advance, such that the first present elements when located at different positions on the display interface correspond to different velocity values, thereby simulating the snowfall or rainfall effect in the real environment.

Based on the above, there may be three kinds of elements that determine the preset present mode. Any two of the above may be combined, or the above three elements may be combined to obtain a corresponding present mode.

A first preset present mode includes the following: the initial position and the initial velocity are combined, and in this case, the preset present mode is that the first present element falls from the initial descending position at the initial velocity, which is equivalent to simulating a vacuum environment. A second preset present mode includes the combination of the initial position and the gravity information, and in this case, the preset present mode may be a free-fall motion of the first present element on the display interface. A third preset present mode includes the following: the combination of the initial velocity and the gravity information. The gravity information may be added based on the initial velocity of the first present element at any position of the display interface, and the velocities of each first present element at different positions of the display interface are determined, thereby displaying the corresponding first present element. A fourth preset present mode includes the combination of the initial velocity, the initial position, and the gravity information. In this case, under the action of the gravity, the first present element is displayed with the initial velocity on the display interface from the initial position.

In this embodiment, after the effect operation is triggered, the plurality of first present elements may be dynamically presented on the display interface according to the corresponding preset present mode, thereby obtaining a video including the corresponding first present elements. For display content of a target main element in the video, reference may be made to a detailed description in this embodiment.

In this embodiment, the effect trigger operation includes at least one of the following: triggering an effect display control; triggering an effect prop for displaying the first present elements; and detecting that a framing image includes the main element.

In this embodiment, the effect processing control may be a button displayed on the display interface of the application software, and triggering the button represents that a corresponding effect needs to be displayed. Alternatively, after the user selects the effect display control, an effect prop display page may pop up on the display interface, and the display page may display a plurality of effect props. The user may trigger the effect prop for displaying the first present element. After the user triggers the effect prop for displaying the first present element, it indicates that the effect trigger operation is triggered. Another method may be that when it is detected that the framing image includes the main element, it is considered that the meteorological effect needs to be displayed. Alternatively, a target object is preset, and it is detected that the framing image includes the target object, indicating that the effect operation is triggered.

S120: in response to the relative present information between the at least one first present element and the main element being a persistence presentation, the at least one first present element is displayed on the main element; and the first present element having relative present information with the main element being a non-persistence presentation is continuously dynamically presented according to the preset present mode.

In this embodiment, a person or object on the display interface that is distinguished from the first present element may be considered as the main element. During research and development, a plurality of main elements to be selected may be set. When the effect prop is triggered, the main elements to be selected are presented on the display interface, and the main element is determined according to the trigger operation of the user on the main elements to be selected. When the effect is developed, the main element stacked and displayed with the first present element may also be determined. The main element may be understood as a part or object that carries the first present element. Optionally, the main element may be the eyes or the tip of the nose, etc. on the face.

In this embodiment, the main element may be any user or object presented on the display interface, and may also be one or more parts of the user body or pet body. The part may be a facial part, or any position on the face, such as a cheekbone part, a chin part, or a randomly selected position on the face. The part may also be any part on the limbs and torso, such as shoulders, palms, and arms.

It should be understood that the part includes at least one of a plurality of parts of the face and a plurality of parts of the limbs and torso. That is, there may be one or more main elements, and the specific number is matched with an effect to be presented in the research and development stage. Regardless of whether the number of main elements is one or more, the relative present mode among the rest of first present elements is the same.

The persistence presentation may be understood in a way that there is one or more first present elements in a current video frame falling on the main element, that is, at least one first present element is stacked and displayed on the main element. Exemplarily, when the first present element is the snowflake element and the main element represents the eyes, the persistence presentation may be understood as a plurality of snowflake elements falling on the eyelashes of the eyes.

Whether it is the persistence presentation may be determined according to position information of the first present element on the display interface and relative position information between the first present element and the main element. Optionally, the relative position information includes a distance value. When the distance value is less than a preset distance threshold, it indicates that the first present element needs to be stacked on the main element, namely as the persistence presentation; and when the distance value is greater than or equal to the preset distance threshold, the first present element may be continuously presented according to the preset present mode.

In an embodiment, the method for determining relative present information between each first present element and the main element is the same, and therefore a description is made with one of meteorological pixel processing as an example, the first present element is determined as the current first present element. When the current first present element is presented according to the preset present mode, position information of the current first present element on the display interface may be determined, and based on the position information and position information of the main element, whether the current first present element needs to be displayed on the main element is determined. When the current first present element needs to be displayed on the main element, the first present element is displayed on the main element. When the current first present element does not need to be displayed on the main element, it indicates that the current first present element may be continuously presented according to the preset present mode.

Exemplarily, the first present element is the snowflake element, and the main element may be an eye area of a target facial image collected based on a camera on the terminal device. After a meteorological effect prop is triggered, the plurality of snowflake elements may be displayed on the display interface according to a preset mode. When it is detected that the display interface is displayed with an eye area, relative position information between the eye area and the snowflake elements is determined. When the relative position information overlaps or the distance indicated by the relative position information is less than the preset distance threshold, the snowflake elements may be displayed on the eyes, thereby obtaining an effect schematic diagram shown in FIG. 2, where the snowflake elements 1, as the first present elements, are displayed on eye elements 2 as the main element.

Based on the foregoing embodiment, it should be noted that when only one first present element and the main element have relative present information as the persistence presentation, the first present element may be displayed on the main element. When the plurality of first present elements and the main element have relative present information as the persistence presentation, the plurality of first present elements may be grouped to be displayed on the main element, namely a stacked persistence presentation. The stacked persistence presentation may also be understood in a way that the main element may already have the first present elements thereon, and when other first present elements, in addition to those already displayed on the main element, are still determined from the current video frame and need the persistence presentation, the other first present elements may be stacked on the existing first present elements. Certainly, during the non-persistence presentation, the presentation may continue according to the preset mode.

In this embodiment of the disclosure, when triggering the prop for displaying a first present element is detected, the plurality of first present elements, such as the simulated snowflake particle elements may be presented on the display interface according to the preset present mode. Meanwhile, during the presentation, the relative present information between the first present elements and the main element may be determined. Optionally, the main element may represent the eye area, and when the relative present information indicates the persistence presentation, the first present elements that satisfy the persistence presentation may be stacked on the main element to obtain the effect of snowflakes falling on the eyelashes, and the other first present elements in the non-persistence presentation are continuously presented according to the preset mode to obtain a video of snowflakes falling on the eyelashes. The problem that in the related art, interactivity between the effect prop and the user is poor, leading to a poor video content effect is solved, and the interest of the video shooting content and interactivity between the effect elements and the user are improved, thereby improving use experience of the user, and further enhancing engagement between the user and products. Based on the foregoing embodiment, when the main element indicates the eye area of the user, before determining relative present information between the first present element and the main element, the method further includes determining an absence of a first display element being stacked on the eye part in response to determining that the eyes are in a closed state according to key points of the eye area.

It should be understood that for each video frame, the key points of the eye area may be determined. Whether the eyes are in the closed state or an open state may be determined according to the key points of the eye area. When the eyes are in the closed state, it indicates that the first present elements may slide from the eye area, and in this case, it is unnecessary to determine relative present information between each first present element and the eye area. In this case, the display position of each first present element in each video frame may be determined according to the preset present mode. That is, each first present element is continuously presented according to the preset present mode. Correspondingly, when the eyes are in the open state according to the key points of the eye area, whether the first present elements fall on the eyelashes of the eye area may be determined, and then the corresponding first present elements are stacked on the eyelashes of the eye area, thereby obtaining the effect of the snowflakes falling on the eyelashes.

### Embodiment 2

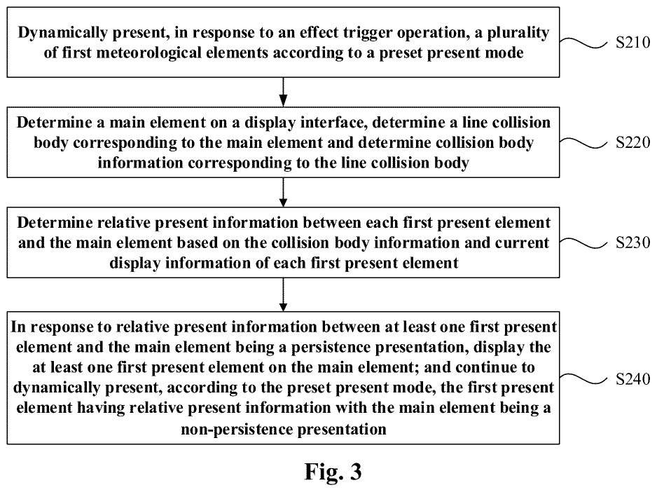

FIG. 3 is a schematic flowchart of an image present method according to Embodiment 2 of the disclosure. Based on the foregoing embodiment, before determining relative present information between the first present element and the main element, a line collision body and collision body information of the main element may be determined, and then based on the collision body information and current display information of each first present element, relative present information between each first present element and the main element is determined. For a present mode, reference may be made to a detailed description in this embodiment. Terms that are the same with or corresponding to those in the foregoing embodiment are not repeated herein.

As shown in FIG. 3, the method includes the following:

S210: in response to an effect trigger operation, a plurality of first present elements are dynamically presented according to a preset present mode.

S220: a main element on a display interface is determined, and a line collision body corresponding to the main element and collision body information corresponding to the line collision body are determined.

In this embodiment, when an effect control is triggered, a collected image may be presented on the display interface, and the image may include or may not include the main element. As long as the image is collected, a key point detection technology may be adopted to determine whether the display interface includes the main element. In response to determining that the display interface includes the main element, the line collision body of the main element may be constructed based on this embodiment of the disclosure, thereby determining the corresponding collision body information.

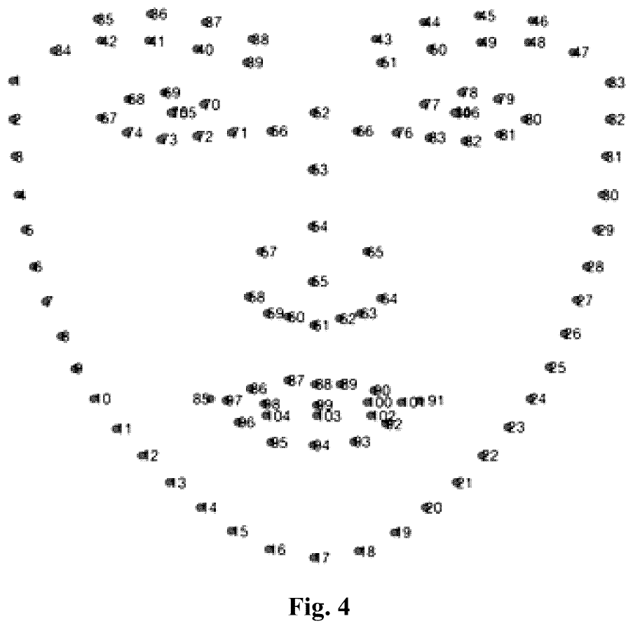

Exemplarily, the main element represents an eye area in a facial image. When image acquisition is performed based on a display device, key points corresponding to the left eye in the eye area may be determined as 67-74-73-72-71-66-70-69-68-67 based on a face detection technology, as shown in FIG. 4. The line collision body is composed of a plurality of line segments. In this case, the plurality of line segments of the eye area may be combinations of two adjacent key points. Typically, the first present element may not be stacked in a concave position, and optionally, at the lower eyelashes, and therefore, based on key points corresponding to the upper eyelid, a line collision body A (66-70-69-68-67) is constructed. The line collision body A may include 4 line segments. By determining relative present information between the first present element and each line segment, whether the corresponding first present element needs a persistence presentation is determined.

In this embodiment, constructing a line collision body corresponding to the main element and determining collision body information may include: at least two key points corresponding to the main element are determined; and the line collision body is determined according to the at least two key points, point coordinate information of the corresponding key points on the line collision body is recorded, and the point coordinate information is determined as the collision body information, where the line collision body includes at least one collision line segment, and two endpoints of the collision line segment correspond to the key points.

Typically, the main element may be a certain part. An edge contour of the main element is determined, and each point on the edge contour is determined as a key point. Alternatively, a plurality of points determined according to a certain rule are determined as key points. The main element may be obtained after sequentially connecting the plurality of key points. The two adjacent points, or key points separated by one or two points may form a collision line segment in the line collision body. Coordinate information of the two endpoints of the collision line segment may be recorded and determined as the collision body information.

In this embodiment, when the set main element is any part of the facial image, determining the at least two key points may be based on the key point recognition algorithm, and at least three key points of each part are determined, such that the line collision body is constructed based on the at least three key points.

Exemplarily, the main element corresponds to the face parts, and based on the key point recognition algorithm, the contour of the face parts may be recognized, resulting in a schematic diagram shown in FIG. 4. After at least three key points of each part are obtained, at least one collision line segment may be obtained according to any two adjacent key points or key points separated by one or two points. The line collision body is determined according to the at least one collision line segment. Meanwhile, pixel point coordinate information of the key points may be determined as the collision body information.

S230: relative present information between each first present element and the main element is determined based on the collision body information and the current display information of each first present element.

It should be further noted that the number of line collision bodies is matched with the number of main elements. The method for determining relative present information between the first present element and each main element is the same, and determining relative present information between one of the first present elements and one main element is determined as an example for the description.

In this embodiment, the current display information may be the current position information of the first present element. The relative present information between each first present element and the main element is determined based on the current position information and coordinate information of the two endpoints of each collision line segment in the collision body information. For each line segment, whether the first present element falls on the line segment may be determined according to the position information of the current line segment and the current position information of each first present element. When the first present element falls on the line segment, the relative present information indicates the persistence presentation; and when the first present element does not fall on the line segment, the relative present information indicates the non-persistence presentation. That is, the persistence presentation may be understood as the need for the first present element to be displayed on the main element.

In this embodiment of the disclosure, determining relative present information between each first present element and the main element based on line collision body information and current display information of each first present element may include: for each first present element, distance information between the current first present element and the line collision body in a normal vector direction is determined, and whether there is an intersection point between a projection point of the current first present element in the normal vector direction and a line segment of the line collision body is determined, where the normal vector direction is determined according to collision point information of the line collision body; and in response to the distance information being less than a preset collision distance threshold and there being the intersection point, it is determined that the relative present information between the current first present element and the corresponding line collision body is the persistence presentation.

It should be noted that because each line collision body includes at least one collision line segment, the relative present information between the first present element and the line collision body may be represented by the relative present information between the first present element and the collision line segment.

In this embodiment, a normal vector of the collision line segment may be determined according to the coordinate information of the two endpoints of the collision line segment. The current display information of the first present element includes position information, and the position information may be represented by coordinates. Based on meteorological pixel coordinates and the normal vector, a distance value between the first present element and the collision line segment in the normal vector direction may be determined. Meanwhile, whether there is an intersection point between a projection point of the first present element in the normal vector direction and the collision line segment is determined based on coordinate information. When the distance value is less than the preset collision distance threshold, and meanwhile there is the intersection point, it indicates that the first present element collides with the line collision body, and correspondingly, the relative present information indicates the persistence presentation.

Based on the above content, in response to the distance value being greater than the preset collision distance threshold or there being no intersection point, the relative present information between the current first present element and the corresponding line collision body indicates the non-persistence presentation. Correspondingly, the continuous dynamic presentation of the first present element having the relative present information with the main element being non-persistence presentation according to the preset present mode includes the following: the first present element that is in non-persistence presentation is continuously presented on the display interface dynamically on the basis of the previous video frame according to the preset present mode.

In an embodiment, when the distance value is less than the preset collision distance threshold, it indicates that the first present element is far away from the line collision body, or there is no intersection point between the first present element and the collision line segment in the normal vector projection direction, it indicates that the first present element may not fall on the main element, and in this case, the relative present information between the first present element and the main element indicates the non-persistence presentation.

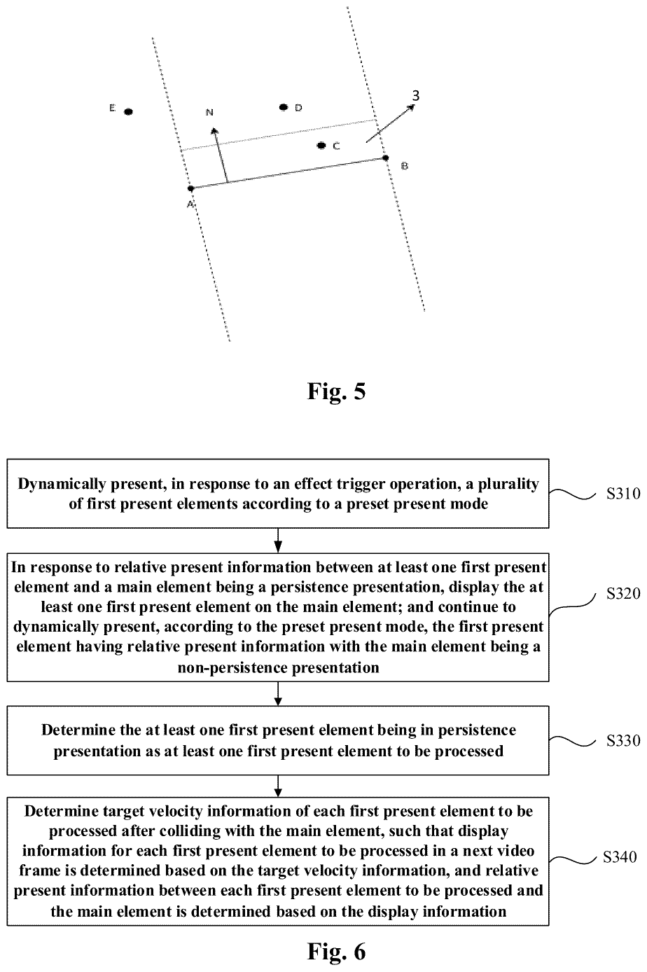

Exemplarily, referring to FIGS. 5, C, D, and E represent first present elements, and A and B represent two endpoints of one collision line segment of the line collision body, namely recognized key points of the main element. A normal vector N of the line segment AB is determined based on coordinate information of the two endpoints A and B. The preset collision distance threshold corresponds to a region 3 in FIG. 5. For the first present element C, a distance value between the first present element C in a normal direction and the line collision body AB may be determined based on current position information of the first present element C. Meanwhile, whether there is an intersection point between a projection of the first present element C in the normal vector direction and the line segment AB may be determined based on the current position information. When the distance value is less than the preset collision distance threshold, that is, the first present element C is located in the region 3, and there is an intersection point, it indicates that the first present element C collides with the line collision body AB, which may be understood as the relative present information between the first present element C and the collision line segment AB indicating the persistence presentation. For current position information of the first present element D, it is determined that a distance value between the first present element D in the normal direction and the line collision body AB is greater than the preset distance threshold, that is, the first present element D is not located in the region 3, and meanwhile it is determined that there is an intersection point between a projection of the first present element D in the normal vector direction and AB, it indicates that the first present element D may fall on the line collision body, but currently does not fall on the line collision body. For the first present element E, it may be seen that a distance value between the first present element E in the normal direction and the line collision body AB is greater than the preset collision distance threshold, and there is no intersection point between a projection of the first present element E in the normal vector direction and AB, it indicates that the first present element E is continuously presented according to the preset present mode.

S240: in response to relative present information between at least one first present element and the main element being a persistence presentation, the at least one first present element is displayed on the main element; and the first present element having relative present information with the main element being a non-persistence presentation is continuously dynamically presented according to the preset present mode.

In an embodiment, in response to the relative present information between the first present element and the main element being the persistence presentation, the corresponding first present element may be stacked and displayed on the main element. The first present element having the relative present information with the main element being the non-persistence presentation is continuously dynamically presented according to the preset present mode.

According to this embodiment of the disclosure, before determining relative present information between the main element and each first present element, the main element on the display interface may be first determined, and the line collision body corresponding to the main element and the collision body information are constructed, and then the relative present information between each first present element and the main element is determined based on the line collision body and the corresponding collision body information, thereby determining whether the first present element needs to be in persistence presentation on the main element. When the first present element needs to be in persistence presentation on the main element, the first present element may be stacked and displayed on the main element, thereby achieving the effects that meteorological information in the real environment is simulated in the video content, and the richness of the video content is improved.

### Embodiment 3

FIG. 6 is a schematic flowchart of an image present method according to Embodiment 3 of the disclosure. Based on the foregoing embodiment, when the first present element collides with the line collision body, the velocity of the first present element correspondingly changes, optionally in velocity magnitude, direction, etc. Correspondingly, the main element may also generate a corresponding movement velocity. For example, the first present element is stacked and displayed on the eyebrows, and when the user raises the eyebrows, the velocity of the main element may be superimposed to the velocity of the first present element falling on the eyebrows, thereby obtaining target velocity information. Display information of a corresponding first present element in a next video frame is determined based on the target velocity information, thereby obtaining a target video including an effect of the first present element. For a specific implementation, reference may be made to a detailed description of this embodiment. Technical terms that are the same with or corresponding to those in the foregoing embodiment are not repeated herein.

As shown in FIG. 6, the method includes the following:

S310: in response to an effect trigger operation, a plurality of first present elements are dynamically presented according to a preset present mode.

S320: in response to relative present information between at least one first present element and a main element being a persistence presentation, the at least one first present element is displayed on the main element; and the first present element having relative present information with the main element being a non-persistence presentation is continuously dynamically presented according to the preset present mode.

S330: the at least one first present element being in the persistence presentation is determined as at least one first present element to be processed.

It should be noted that the persistence presentation is a present mode that the first present element collides with a line collision body of the main element in a current video frame, and then the first present element needs to be stacked on the line collision body. The first present element in the non-persistence presentation is continuously presented according to the preset present mode; while when the first present element in the persistence presentation collides with the line collision body, based on collision acting force, velocity information of the first present element during the collision, and gravity information of the first present element, the velocity greatly of the first present element changes compared to the velocity of the first present element during being presented based on the preset present mode, and in this case, target velocity information of the type of first present element is determined. The first present element colliding with the main element is determined as at least one first present element to be processed.

S340: target velocity information of each first present element to be processed after colliding with the main element is determined, such that display information of each first present element to be processed in a next video frame is determined based on the target velocity information, and relative present information between each first present element to be processed and the main element is determined based on the display information.

In this embodiment, the corresponding velocity information obtained after the first present element to be processed collides with the line collision body of the main element is determined as the target velocity information. The target velocity information may be a vector velocity, namely a velocity with a magnitude and direction. The target velocity information may be determined based on the momentum conservation law or energy conservation. In this embodiment, determining the target velocity information has the advantages that the display information of the first present element to be processed in the next video frame may be determined based on the target velocity information; and meanwhile, display information of each of other first present elements in the next video frame is determined based on the preset present mode, and whether each first present element in the next video frame needs to be stacked to the main element to be displayed is determined based on the display information, thereby obtaining a target video including the effect of the first present element.

In this embodiment, determining target velocity information of the first present element to be processed after colliding with the main element includes the following: for each first present element to be processed, relative velocity information to be updated of the current first present element to be processed relative to the corresponding line collision body is determined; based on the relative velocity information to be updated, a first projection component of the relative velocity information to be updated in a normal vector direction of the line collision body is determined; the relative velocity information to be updated is updated based on the first projection component to obtain velocity information to be used of the current first present element to be processed; and according to the velocity information to be used and an average movement velocity of the line collision body, the target velocity information of the current first present element to be processed is determined.

In an embodiment, the line collision body includes a plurality of collision line segments. Each collision line segment corresponds to an average movement velocity. When the first present element collides with the line collision body, the corresponding collision line segment may be determined. Determining an average movement velocity of the collision line segment AB includes the following: historical position information of a point A and a point B in a current video frame is determined, and current position information of the point A and the point B in the current video frame is determined. For the point A, a distance between the historical position information and the current position information is calculated, and a movement velocity of the point A is determined based on a duration of each video frame. For a movement velocity of the point B, the above steps may be repeatedly performed. A velocity mean value of the movement velocity of the point A and the movement velocity of the point B is calculated to obtain the average movement velocity v_collider of the collision line segment AB. The first present element is presented according to the preset mode. Optionally, the preset present mode may be a free-fall motion, and based on that, the corresponding movement velocity v_snow of the first present element in the current video frame may be obtained. Based on a velocity difference between the movement velocity of the first present element and the average movement velocity of the collision line segment, the relative velocity information to be updated v_rel=v_snow-v_collider is determined. By dot multiplying the relative velocity information to be updated with a normal vector of the collision line segment, the first projection component v_n=dot (v_rel, normal) is obtained, where normal represents the normal vector of the collision line segment. The velocity information to be used is a velocity obtained after processing the relative velocity information to be updated based on the first projection component. The target velocity information is determined based on the velocity information to be used and the average movement velocity of the corresponding collision line segment.

In this embodiment, updating the relative velocity information to be updated based on the first projection component to obtain velocity information to be used of the current first present element to be processed may include: in response to the first projection component being less than a preset projection component threshold, a second projection component of the relative velocity information to be updated in a tangent vector direction of the line collision body is determined; and in response to the second projection component being less than a static friction critical velocity, the relative velocity information to be updated is determined as a first preset relative velocity and is determined as the velocity information to be used.

In this embodiment, the preset projection component threshold is 0 preset based on experience. When v_n<0, the projection component of the relative velocity information to be updated in the tangent vector direction of the collision line segment is calculated to obtain a second projection component to be used v_tangent=v_rel-v_n*norma. That is, the second projection component to be used is determined according to the relative movement velocity to be updated, the first projection component, and the normal vector of the collision line segment. The second projection component is determined according to the second projection component to be used, optionally, the second projection component v_tan_len=length (v_tangent), where length represents the magnitude of the second projection component to be used. The second projection component represents the magnitude of the relative movement velocity information to be updated in the tangent vector. The product of a static friction coefficient and the first projection component is calculated to obtain the static friction critical velocity. The static friction coefficient is typically set to any value between 0 and 1. When the second projection component is less than the static friction critical velocity, the velocity information to be used is determined as the first preset relative velocity, and the first preset relative velocity may be 0 m/s. It should be understood that when the second projection component is less than the static friction critical velocity, the relative velocity information to be updated may be updated to the first preset relative velocity. The first preset relative velocity is determined as the velocity information to be used.

Based on the foregoing embodiment, in response to the second projection component being greater than the static friction critical velocity, the relative velocity to be updated is updated based on the static friction coefficient, the second projection component, and the first projection component, so as to obtain the velocity information to be used. Exemplarily, when it is determined that the second projection component is greater than the static friction critical velocity, the relative velocity to be updated is updated based on a formula to obtain the velocity information to be used. The formula may be:

$$v\_rel = ( 1 + friction\_coef * v\_n / v\_tan \_len ) * v\_tangent$$

friction_coef represents the static friction coefficient.

By substituting the static friction coefficient, the second projection component, and the first projection component to the above formula, the relative velocity information to be updated is updated to obtain the velocity information to be used.

Based on the foregoing embodiment, in response to the first projection component being greater than the preset projection component threshold, the target processing method is determined to use the relative velocity information to be updated as the velocity information to be used.

It should be understood that when the first projection component is greater than the preset projection component threshold, the initially-determined relative movement velocity to be updated may be determined as the velocity information to be used.

After the velocity to be used is determined, the target velocity information of the current first present element to be processed may be determined according to the velocity information to be used and the average movement velocity of the line collision body.

Optionally, the target velocity information may be determined based on the formula: vel=v_rel+v_collider, where v_rel represents the finally determined velocity to be used, and v_collider represents the average movement velocity of the collision line segment colliding with snowflake elements. In this embodiment, after the target velocity information of each first present element to be processed is determined, the target velocity information may be fed back to an MPM framework, such that the MPM framework may determine display information of the corresponding first present element to be processed based on the returned target velocity information and a preset position determination function. Meanwhile, based on the preset present mode, display information of each first present element displayed without stack is determined. After the display information is determined, the above steps may be repeatedly performed, a display position of each meteorological pixel in the next video frame is determined, and the corresponding first present element is rendered to obtain the next video frame. The above steps are repeatedly performed, such that a target video that the first present element is stacked on the corresponding main element can be obtained.

In this embodiment of the disclosure, after determining that the first present element collides with the main element, the velocity information of the first present element after the collision may be determined, so as to determine the display information of the corresponding first present element in the next video frame based on the velocity information after the collision, thereby obtaining the target video with dynamic changes or relatively static changes of the first present element and the main element.

### Embodiment 4

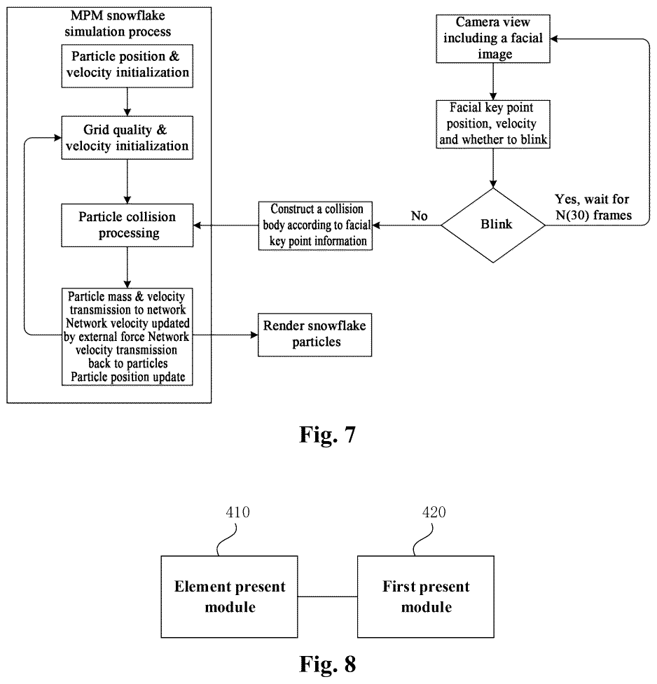

As an optional embodiment of the foregoing embodiment, FIG. 7 is a schematic flowchart of an image present method according to Embodiment 4 of the disclosure. In this embodiment, a main element is an eye area in face parts, and a first present element is a snowflake element. The display of the snowflake element may be implemented through snowflake particles. That is, a compute shader is deployed in a mobile terminal, and a simulation effect of MPM construction of snowflakes is achieved based on the compute shader. To determine the main element in the display interface, a face detection technology may be adopted to determine facial points of the eye area in a video image.

In an embodiment, after an effect prop is triggered, an image including face parts may be collected, and key points of the eye area are determined, as shown in FIG. 4. Whether the eye area blinks may be determined based on positions and velocities of the key points. When it is determined that the eye area blinks, it indicates that the snowflakes may not fall on the eyes. When the eye area is not in a blinking state, a collision body may be constructed based on facial key point information. Optionally, if it is determined that a left eye line collision body is constructed by 67-73-71, 76-82-80 may be selected as a right eye line collision body. A line connecting two adjacent points in the collision body is determined as a collision line segment. Coordinate information of two endpoints of the collision line segment on the line collision body is recorded, and a normal vector of the collision line segment determined based on the coordinate information is recorded. For each collision line segment, positions and velocities of the two endpoints of the collision line segment may be obtained during running. Based on the endpoint velocities, an average velocity of the collision line segment may be determined, and meanwhile the normal vector of the collision line segment may be determined.

In an MPM framework, the snowflake particles may be adjusted to fall from corresponding positions based on preset initial velocities and initial positions of the snowflake particles, and set gravity information of the snowflake particles. Distance information between each snowflake particle in a normal vector direction of each collision line segment and the collision line segment is calculated. Meanwhile, whether there is an intersection point between a projection of the snowflake particle in the normal vector direction and the collision line segment is determined. When the two above conditions are satisfied, it is determined that the snowflake particle collides with the collision line segment. When any one of the above conditions is not satisfied, it indicates that the snowflake particle does not collide with the collision line segment. The snowflake particles which are not in collision may be continuously displayed according to the preset present mode, and target velocity information is determined according to the preset present mode. The target velocity information of the snowflake particles to be processed that are in collision may be determined through the following method.

It should be noted that the method for determining target velocity information of each snowflake particle to be processed is the same, and one of the snowflake particles to be processed may be determined as an example for illustration.

The relative movement velocity of the current snowflake particle relative to the collision line segment is determined as v_rel=v_snow-v_collider. A first projection component of the relative movement velocity in the normal vector (normal) direction of the collision line segment is determined as v_n=dot (v_rel, normal). When v_n<0, a second projection component to be used of the relative movement velocity of the snowflake particle in the tangent vector direction of the collision line segment is determined as v_tangent=v_rel-v_n*normal. According to the second projection component to be used, a second projection component is determined as v_tan_len=length (v_tangent), where length represents magnitude information of the second projection component of the vector. In response to the second projection component being less than the static friction critical velocity-v_n*friction_coef (friction_coef represents the static friction coefficient and ranges from 0 to 1), the relative movement velocity is the velocity to be used v_rel=0; and in response to the second projection component being greater than the static friction critical velocity, the relative movement velocity is the velocity to be used v_rel=(1+friction_coef*v_n/v_tan_len)*v_tangent.

When v_n>0, the velocity to be used is determined as v_rel=v_snow-v_collider.

After the velocity to be used is determined based on the above, the velocity, namely the target velocity of the snowflake particle after the collision may be determined based on the velocity to be used and the movement velocity of the collision line segment, and the formula for determining the target velocity information may be vel=v_rel+v_collider, where vel denotes the target velocity, v_rel denotes the finally updated velocity to be used, and v_collider denotes the average movement velocity of the collision line segment. Based on the target velocity information, the snowflake particle may move in the display interface, such that a display position of the snowflake particle in the next video frame can be obtained, and the above steps are repeatedly performed to obtain a target video including each snowflake particle.

In this embodiment of the disclosure, when triggering a first present element display prop is detected, the plurality of first present elements, such as the simulated snowflake particle elements may be presented on the display interface according to the preset present mode. Meanwhile, during the presentation, the relative present information between the first present elements and the main element may be determined. Optionally, the main element may represent the eye area, and when the relative present information indicates the persistence presentation, the first present elements that satisfy the persistence presentation may be stacked on the main element to obtain the effect of snowflakes falling on the eyelashes, and the other first present elements in the non-persistence presentation are continuously displayed according to the preset mode to obtain a video of snowflakes falling on the eyelashes. The problem that in the related art, interactivity between the effect prop and the user is poor, leading to a poor video content effect is solved, and the interest of the video shooting content and interactivity between the effect elements and the user are improved, thereby improving use experience of the user, and further enhancing engagement between the user and products. Based on the foregoing implementation, when the main element is the eye area of the user, before determining relative present information between the first present element and the main element, the method further includes: it is determined that there are no first present elements stacked on the eye area in response to determining that the eye area is in a closed state according to the key points of the eye area.

### Embodiment 5

FIG. 8 is a structural schematic diagram of an image present apparatus according to Embodiment 5 of the disclosure. As shown in FIG. 8, the apparatus includes: an element present module 410 and a first present module 420.

The element present module 410 is configured to dynamically present, in response to an effect trigger operation, a plurality of first present elements according to a preset present mode. The first present module 420 is configured to display, in response to relative present information between at least one first present element and a main element being a persistence presentation, the at least one first present element on the main element; and continue to dynamically present, according to the preset present mode, the first present element having relative present information with the main element being a non-persistence presentation.

Optionally, the effect trigger operation includes at least one of the following:
triggering an effect display control;
triggering an effect prop for displaying the first present element; and
detecting that a framing image includes the main element.

Optionally, the apparatus further includes: a preset present mode determination module, configured to determine the preset present mode based on at least two of a preset initial position, initial velocity, and gravity information of each first present element.

Optionally, the apparatus further includes: a collision body construction module, including:
a collision body construction unit, configured to determine a main element on a display interface, determine a line collision body corresponding to the main element and determine collision body information corresponding to the line collision body; and
a relative present information determination unit, configured to determine relative present information between each first present element and the main element based on the collision body information and current display information of each first present element.

Optionally, the collision body construction unit includes:
a key point determination unit, configured to determine at least two key points corresponding to the main element; and
a collision information determination unit, configured to determine a line collision body according to the at least two key points, record point coordinate information of the corresponding key points on the line collision body, and determine the point coordinate information as the collision body information, where the line collision body includes at least one collision line segment, and two endpoints of the collision line segment correspond to the key points.

Optionally, the key point determination unit is further configured to determine, in response to the main element corresponding to at least one part of a target user on the display interface, at least three key points of each part based on a key point recognition algorithm so as to construct a line collision body based on the at least three key points.

Optionally, the at least one part includes at least one of a plurality of parts of the face and a plurality of parts of the limbs and torso.

Optionally, it is determined an absence of a first present elements being stacked on the eye part in response to determining that the eye part is in a closed state according to the key points of the eye part.

Optionally, the relative present information determination unit includes:
a first information determination sub-unit, configured to determine, for each first present element, a distance value between the current first present element and the corresponding line segment in a normal vector direction of the corresponding collision line segment on the line collision body according to position information of the current first present element, and determine whether there is an intersection point between a projection point of the current first present element in the normal vector direction and the collision line segment, where the normal vector direction is determined according to key point information corresponding to two endpoints of the collision line segment; and
a persistence presentation determination sub-unit, configured to determine, in response to the distance value being less than a preset collision distance threshold and there being the intersection point, that the relative present information between the current first present element and the corresponding line collision body is the the persistence presentation.

Optionally, the first present module is further configured to stack the at least one first present element on the main element.

Optionally, the relative present information determination unit is further configured to: determine, in response to the distance value being greater than the preset collision distance threshold or there is an absence of the intersection point, that the relative present information between the current first present element and the corresponding line collision body indicates a non-persistence presentation. Correspondingly, the continuous dynamic display of the first present element having the relative present information with the main element that indicates the non-persistence presentation according to the preset present mode includes: the first present element that is in non-persistence presentation is continuously displayed on the display interface dynamically on the basis of the previous video frame according to the preset present mode.

Optionally, the first present element includes at least one of a snowflake element, a water droplet element, and a hail element.

Optionally, the apparatus further includes:
a first present element to be processed determination module, configured to determine at least one first present element being in persistence presentation as at least one first present element to be processed; and
a target velocity determination module, configured to determine target velocity information of the first present element to be processed after colliding with the main element so as to determine display information of each first present element to be processed in a next video frame based on the target velocity information, and determine relative present information with the main element based on the display information.

The display information includes display position information.

Optionally, the target velocity determination module is further configured to: determine, for each first present element to be processed, relative velocity information to be updated based on a movement velocity of the current first present element to be processed and an average movement velocity of the corresponding collision line segment in the line collision body, where the average movement velocity is determined according to position information of two endpoints of the collision line segment in a previous video frame and position information of the two endpoints of the collision line segment in a current video frame; determine, based on the relative velocity information to be updated, a first projection component of the relative velocity information to be updated in a normal vector direction of the line collision body; update the relative velocity information to be updated based on the first projection component to obtain velocity information to be used of the current first present element to be processed; and determine target velocity information of the current first present element to be processed according to the velocity information to be used and the average movement velocity of the line collision body.

Optionally, the target velocity determination module is further configured to: determine, in response to the first projection component being less than a preset projection component threshold, a second projection component of the relative velocity information to be updated in a tangent vector direction of the line collision body; and determine, in response to the second projection component being less than a static friction critical velocity, the velocity information to be used as a first preset relative velocity, where the static friction critical velocity is determined based on the first projection component and the static friction coefficient.

Optionally, the target velocity determination module is further configured to: update, in response to the second projection component being greater than the static friction critical velocity, the relative velocity information to be updated based on the static friction coefficient, the second projection component, and the first projection component, so as to obtain the velocity information to be used.

Optionally, the target velocity determination module is further configured to: determine, in response to the first projection component being greater than the preset projection component threshold, the target processing method to use the relative velocity information to be updated as the velocity information to be used.

Optionally, the target velocity determination module is further configured to:

determine display information of the corresponding first present element to be processed in the next video frame according to the target velocity information of each first present element to be processed and normal vector gravity information of the belonging line collision body; determine, based on the preset present mode, display information of each first present element displayed without stack; and determine, based on the display information, relative present information between each main element and each first present element in the next video frame.

In this embodiment of the disclosure, when triggering a first present element display prop is detected, the plurality of first present elements, such as the simulated snowflake particle elements may be presented on the display interface according to the preset present mode. Meanwhile, during the presentation, the relative present information between the first present elements and the main element may be determined. Optionally, the main element may represent the eye area, and when the relative present information indicates the persistence presentation, the first present elements that satisfy the persistence presentation may be stacked on the main element to obtain the effect of snowflakes falling on the eyelashes, and the other first present elements in the non-persistence presentation are continuously presented according to the preset mode to obtain a video of snowflakes falling on the eyelashes. The problem that in the related art, interactivity between the effect prop and the user is poor, leading to a poor video content effect is solved, and the interest of the video shooting content and interactivity between the effect elements and the user are improved, thereby improving use experience of the user, and further enhancing the engagement effect between the user and products.

The image present apparatus provided by this embodiment of the disclosure may execute the image present method provided by any embodiment of the disclosure, and has the corresponding functional modules and beneficial effects for executing the method.

It should be noted that the various units and modules included in the apparatus are only divided according to functional logics, as long as the corresponding functions may be achieved; and in addition, the specific names of the functional units are only for the convenience of distinguishing each other.

### Embodiment 6

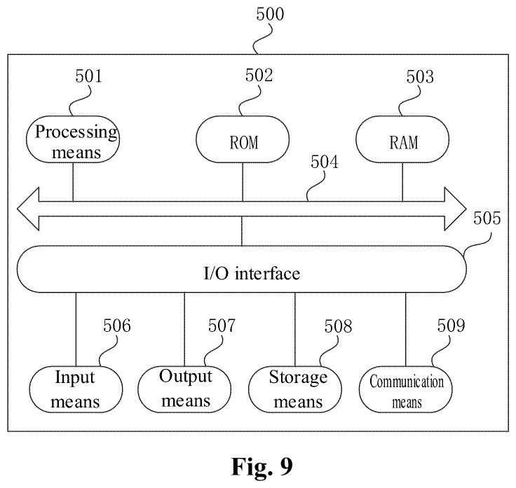

FIG. 9 is a structural schematic diagram of an electronic device according to Embodiment 6 of the disclosure. Referring to FIG. 9 as below, FIG. 9 illustrates a structural schematic diagram of an electronic device (e.g., a terminal device or a server in FIG. 9) 500 applicable to implementing embodiments of the disclosure. The terminal device in this embodiment of the disclosure may include mobile terminals such as a mobile phone, a notebook computer, a digital radio receiver, a personal digital assistant (PDA), a portable Android device (PAD), a portable media player (PMP), and a vehicle-mounted terminal (e.g., a vehicle-mounted navigation terminal), and fixed terminals such as a digital television (TV) and a desk computer. The electronic device shown in FIG. 9 is merely an example.

As shown in FIG. 9, the electronic device 500 may include a processing means (e.g., a central processing unit and a graphics processing unit) 501, which may perform various appropriate actions and processing according to programs stored on a read-only memory (ROM) 502 or loaded from a storage means 508 into a random access memory (RAM) 503. The RAM 503 further stores various programs and data required for the operation of the electronic device 500. The processing means 501, the ROM 502, and the RAM 503 are connected to one another through a bus 504. An input/output (I/O) interface 505 is also connected to the bus 504.

Typically, the following means may be connected to the I/O interface 505: an input means 506, including, for example, a touchscreen, a touchpad, a keyboard, a mouse, a camera, a microphone, an accelerometer, and a gyroscope; an output means 507, including, for example, a liquid crystal display (LCD), a speaker, and a vibrator; the storage means 508, including, for example, a magnetic tape and a hard drive; and a communication means 509. The communication means 509 may allow the electronic device 500 to be in wireless or wired communication with other devices for data exchange. Although FIG. 9 illustrates the electronic device 500 with various means, it should be understood that it is not necessary to implement or have all the shown means. Alternatively, more or fewer means may be implemented or provided.

Particularly, the foregoing process described with reference to the flowchart according to the embodiments of the disclosure may be implemented as a computer software program. For example, an embodiment of the disclosure includes a computer program product including a computer program carried on a non-transitory computer-readable medium. The computer program includes program code for executing the method shown in the flowchart.

In this embodiment, the computer program may be downloaded and installed from the network by the communication means 509, or installed from the storage means 508, or installed from the ROM 502. The computer program, when executed by the processing means 501, performs the above functions in the method in this embodiment of the disclosure.

The names of messages or information exchanged between multiple means in the implementations of the disclosure are provided for illustrative purposes only.

The electronic device provided by this embodiment of the disclosure and the video image present method provided by the foregoing embodiment belong to the same inventive concept, and for technical details not described in detail in this embodiment, reference may be made to the foregoing embodiment. This embodiment and the foregoing embodiment have the same beneficial effects.

### Embodiment 7

Embodiment 7 of the disclosure provides a computer storage medium, storing a computer program. The program, when executed by a processor, implements the image present method provided by the foregoing embodiment.

It should be noted that the computer-readable medium in the disclosure may be a computer-readable signal medium, or a computer-readable storage medium, or any combination of the above. For example, the computer-readable storage medium may include: electrical, magnetic, optical, electromagnetic, infrared, or semiconductor systems, apparatuses, or devices, or any combination of the above. The computer-readable storage medium may include: an electrical connection with one or more wires, a portable computer disk, a hard drive, a random access memory, a read-only memory, an erasable programmable read-only memory (EPROM or a flash memory), fiber optics, a portable compact disc read-only memory (CD-ROM), an optical storage device, a magnetic storage device, or any proper combination of the above. In the disclosure, the computer-readable storage medium may be any tangible medium including or storing a program, and the program may be used by an instruction execution system, apparatus, or device, or used in conjunction with the instruction execution system, apparatus, or device. However, in the disclosure, the computer-readable signal medium may include data signals propagated in a baseband or propagated as a part of a carrier wave, which carry computer-readable program code. The propagated data signals may have a plurality of forms, including electromagnetic signals, optical signals, or any proper combination of the above. The computer-readable signal medium may be any computer-readable medium other than the computer-readable storage medium. The computer-readable signal medium may send, propagate, or transmit the program used by the instruction execution system, apparatus, or device, or used in conjunction with the instruction execution system, apparatus, or device. The program code included in the computer-readable medium may be transmitted by any proper medium including: a wire, an optical cable, radio frequency (RF), etc., or any proper combination of the above.

In some implementations, a client and the server may communicate using any currently known or future-developed network protocols such as a hypertext transfer protocol (HTTP), and may also be in communication connection with digital data in any form or medium (e.g., a communication network). For example, the communication network includes a local area network (LAN), a wide area network (WAN), Internet work (e.g., Internet), a peer-to-peer network (e.g., an ad hoc peer-to-peer network), and any currently known or future-developed networks.

The computer-readable medium may be included in the electronic device; and may separately exist without being assembled in the electronic device.

The computer-readable medium carries one or more programs. The one or more programs, when executed by the electronic device, enable the electronic device to:
dynamically present, in response to an effect trigger operation, a plurality of first present elements according to a preset present mode;
display, in response to relative present information between at least one first present element and a main element being a persistence presentation, the at least one first present element on the main element; and
continue to dynamically present, according to the preset present mode, the first present element having relative present information with the main element being a non-persistence presentation.

The computer program code for executing the operations of the disclosure may be written in one or more programming languages or a combination thereof. The programming languages include object-oriented programming languages such as Java, Smalltalk, C++, as well as conventional procedural programming languages such as “C” or similar programming languages. The program code may be executed entirely or partially on a user computer, executed as a standalone software package, executed partially on the user computer and partially on a remote computer, or entirely executed on the remote computer or server. In the case of involving the remote computer, the remote computer may be connected to the user computer via any type of network, including a LAN or WAN, or may be connected to an external computer (e.g., utilizing an Internet service provider for Internet connectivity).

The flowcharts and block diagrams in the accompanying drawings illustrate system architectures, functions, and operations possibly implemented by the system, method and computer program product according to the various embodiments of the disclosure. In this regard, each block in the flowcharts or block diagrams may represent a module, a program segment, or a portion of code, and the module, program segment, or portion of code includes one or more executable instructions for implementing specified logical functions. It should be noted that in some alternative implementations, functions marked in the blocks may also occur in an order different from that marked in the accompanying drawings. For example, two consecutively-shown blocks may actually be executed in parallel basically, but sometimes may also be executed in a reverse order, which depends on involved functions. It should be further noted that each block in the block diagrams and/or flowcharts as well as a combination of the blocks in the block diagrams and/or flowcharts may be implemented by using a dedicated hardware-based system that executes specified functions or operations, or using a combination of special hardware and computer instructions.

The units described in the embodiments of the disclosure may be implemented through software or hardware. For example, a first acquisition unit may also be described as “a unit for acquiring at least two Internet protocol addresses”.

The functions described above in this specification may be at least partially executed by one or more hardware logic components. For example, exemplary hardware logic components that may be used include: a field programmable gate array (FPGA), an application specific integrated circuit (ASIC), application specific standard parts (ASSPs), a system on chip (SOC), a complex programmable logic device (CPLD), etc.

In the context of the disclosure, a machine-readable medium may be a tangible medium that may contain or store a program, and the program may be used by the instruction execution system, apparatus, or device, or used in conjunction with the instruction execution system, apparatus, or device. The machine-readable medium may be a machine-readable signal medium or a machine-readable storage medium. The machine-readable medium may include electronic, magnetic, optical, electromagnetic, infrared, or semiconductor systems, apparatuses, or devices, or any proper combination of the above content. The machine-readable storage medium may include an electrical connection based on one or more wires, a portable computer disk, a hard drive, a RAM, a ROM, an erasable programmable read-only memory (EPROM or a flash memory), fiber optics, a CD-ROM, an optical storage device, a magnetic storage device, or any proper combination of the above content.

According to one or more embodiments of the disclosure, Example 1 provides an image present method. The method includes:
in response to an effect trigger operation, a plurality of first present elements are dynamically presented according to a preset present mode;
in response to relative present information between at least one first present element and a main element being a persistence presentation, the at least one first present element is displayed on the main element; and
the first present element having relative present information with the main element being a non-persistence presentation is continuously dynamically presented according to the preset present mode.

According to one or more embodiments of the disclosure, Example 2 provides an image present method. The method further includes:
optionally,
the effect trigger operation includes at least one of the following:
triggering an effect display control;
triggering an effect prop for displaying first present elements; and
detecting that a framing image includes the main element.

According to one or more embodiments of the disclosure, Example 3 provides an image present method. The method further includes: a preset present mode is determined.

Optionally, the step of determining a preset present mode includes:
the preset present mode is determined based on at least two of a preset initial position, initial velocity, and gravity information of each first present element.

According to one or more embodiments of the disclosure, Example 4 provides an image present method. The method further includes:
optionally, before the step of displaying, in response to relative present information between at least one first present element and a main element being a persistence presentation, the at least one first present element on the main element, the method further includes:
a main element in a display interface is determined, and a line collision body and collision body information corresponding to the main element are determined; and
relative present information between each first present element and the main element is determined based on the collision body information and current display information of each first present element.

According to one or more embodiments of the disclosure, Example 5 provides an image present method. The method further includes:
optionally, the step of determining a line collision body and collision body information corresponding to the main element includes:
at least two key points corresponding to the main element are determined; and
the line collision body is determined according to the at least two key points, point coordinate information of the corresponding key points on the line collision body is recorded, and the point coordinate information is determined as the collision body information,
where the line collision body includes at least one collision line segment, and two endpoints of the collision line segment correspond to the key points.

According to one or more embodiments of the disclosure, Example 6 provides an image present method. The method further includes:

optionally, the step of determining at least two key points corresponding to the main element includes:

in response to the main element corresponding to at least one part of a target user on the display interface, at least three key points of each part are determined based on a key point recognition algorithm so as to construct a line collision body based on the at least three key points.

According to one or more embodiments of the disclosure, Example 7 provides an image present method. The method further includes:

optionally, the at least one part includes at least one of a plurality of parts of the face and a plurality of parts of the limbs and torso.

According to one or more embodiments of the disclosure, Example 8 provides an image present method. The method further includes:

optionally, the main element is an eye part in the face, and before the step of stacking and displaying, in response to relative present information between at least one first present element and a main element being a persistence presentation, the at least one first present element on the main element, the method further includes:
it is determined that there is an absence of first present elements stacked on the eye part in response to determining that the eye part is in a closed state according to the key points of the eye part.

According to one or more embodiments of the disclosure, Example 9 provides an image present method. The method further includes:
optionally, the step of determining relative present information between each first present element and the main element based on the collision body information and current display information of each first present element includes:
for each first present element, a distance value between the current first present element and the corresponding line segment in a normal vector direction of the corresponding collision line segment on the line collision body, and whether there is an intersection point between a projection point of the current first present element in the normal vector direction and the collision line segment are determined according to position information of the current first present element, where the normal vector direction is determined according to key point information corresponding to two endpoints of the collision line segment; and
in response to the distance value being less than a preset collision distance threshold and there being the intersection point, it is determined that relative present information between the current first present element and the corresponding line collision body is the persistence presentation.

According to one or more embodiments of the disclosure, Example 10 provides an image present method. The method further includes:
optionally, the step of stacking the at least one first present element on the main element for display includes:
the at least one first present element is stacked on the main element.

According to one or more embodiments of the disclosure, Example 11 provides an image present method. The method further includes:
optionally, in response to the distance value being greater than the preset collision distance threshold or there is an absence of the intersection point, it is determined that the relative present information between the current first present element and the corresponding line collision body is the non-persistence presentation; and
correspondingly, the step of continuously dynamically presenting, based on the preset present mode, the first present element having relative present information with the main element being a non-persistence presentation includes:
the first present element that is in non-persistence presentation is continuously presented on the display interface dynamically on the basis of the previous video frame according to the preset present mode.

According to one or more embodiments of the disclosure, Example 12 provides an image present method. The method further includes:
optionally, the first present element includes at least one of a snowflake element, a water droplet element, and a hail element.

According to one or more embodiments of the disclosure, Example 13 provides an image present method. The method further includes:
optionally, the at least one first present element being in the persistence presentation is determined as at least one first present element to be processed; and
target velocity information of each first present element to be processed after colliding with the main element is determined, such that display information of each first present element to be processed in a next video frame is determined based on the target velocity information, and relative present information between each first present element to be processed and the main element is determined based on the display information, where the display information includes display position information.

According to one or more embodiments of the disclosure, Example 14 provides an image present method. The method further includes:
optionally, the step of determining target velocity information of the first present element to be processed after colliding with the main element includes:
for each first present element to be processed, relative velocity information to be updated is determined based on a movement velocity of the current first present element to be processed and an average movement velocity of the corresponding collision line segment in the line collision body, where the average movement velocity is determined according to position information of two endpoints of the collision line segment in a previous video frame and position information of the two endpoints of the collision line segment in a current video frame;
based on the relative velocity information to be updated, a first projection component of the relative velocity information to be updated in a normal vector direction of the line collision body is determined;
the relative velocity information to be updated is updated based on the first projection component to obtain velocity information to be used of the current first present element to be processed; and
target velocity information of the current first present element to be processed is determined according to the velocity information to be used and the average movement velocity of the line collision body.

According to one or more embodiments of the disclosure, Example 15 provides an image present method. The method further includes:
optionally, the step of updating the relative velocity information to be updated based on the first projection component to obtain velocity information to be used of the current first present element to be processed includes:
in response to the first projection component being less than a preset projection component threshold, a second projection component of the relative velocity information to be updated in a tangent vector direction of the line collision body is determined; and
in response to the second projection component being less than a static friction critical velocity, the velocity information to be used is determined as a first preset relative velocity,
where the static friction critical velocity is determined based on the first projection component and the static friction coefficient.

According to one or more embodiments of the disclosure, Example 16 provides an image present method. The method further includes:
optionally, in response to the second projection component being greater than the static friction critical velocity, the relative velocity information to be updated is updated based on the static friction coefficient, the second projection component, and the first projection component, so as to obtain the velocity information to be used.

According to one or more embodiments of the disclosure, Example 17 provides an image present method. The method further includes:
optionally, the step of updating the relative velocity information to be updated based on the first projection component to obtain velocity information to be used of the current first present element to be processed includes:
in response to the first projection component being greater than the preset projection component threshold, the target processing method is determined to use the relative velocity information to be updated as the velocity information to be updated.

According to one or more embodiments of the disclosure, Example 18 provides an image present method. The method further includes:
optionally, display information of the corresponding first present element to be processed in the next video frame is determined according to the target velocity information of each first present element to be processed and normal vector gravity information of the belonging line collision body; based on the preset present mode, display information of each first present element in the non-stack display is determined; and
based on the display information, relative present information between each main element and each first present element in the next video frame is determined.

According to one or more embodiments of the disclosure, Example 19 provides an image present apparatus. The apparatus includes:
an element present module, configured to dynamically present, in response to a effect trigger operation, a plurality of first present elements according to a preset present mode; and
a first present module, configured to display, in response to relative present information between at least one first present element and a main element being a persistence presentation, the at least one first present element on the main element; and
continue to dynamically present, according to the preset present mode, the first present element having the relative present information with the main element being a non-persistence presentation.

1. An image present method, comprising:
dynamically presenting, in response to an effect trigger operation, a plurality of first present elements according to a preset present mode;
displaying, in response to determining that relative present information between at least one first present element and a main element is a persistence presentation, the at least one first present element on the main element; and
continuing to dynamically present, according to the preset present mode, a first present element having relative present information with the main element being a non-persistence presentation.

2. The method according to claim 1, wherein the effect trigger operation comprises at least one of the following:
triggering an effect display control;
triggering an effect for displaying the first present elements; and
detecting that a framing image comprises the main element.

3. The method according to claim 1, further comprising: determining the preset present mode;
wherein determining the preset present mode comprises:
determining the preset present mode based on at least two of a preset initial position, initial velocity, and gravity information of each first present element.

4. The method according to claim 1, further comprising: before displaying, in response to determining that the relative present information between the at least one first present element and the main element is the persistence presentation, the at least one first present element on the main element,
determining the main element on a display interface, determining a line collision body corresponding to the main element and determining collision body information corresponding to the line collision body; and
determining relative present information between each first present element and the main element based on the collision body information and current display information of each first present element.

5. The method according to claim 4, wherein determining the line collision body corresponding to the main element and determining the collision body information corresponding to the line collision body comprises:
determining at least two key points corresponding to the main element; and
determining the line collision body according to the at least two key points, recording point coordinate information of the corresponding key points on the line collision body, and determining the point coordinate information as the collision body information,
wherein the line collision body comprises at least one collision line segment, and two endpoints of the collision line segment correspond to the key points.

6. The method according to claim 5, wherein determining the at least two key points corresponding to the main element comprises:
in response to the main element corresponding to at least one part of a target user on the display interface, determining at least three key points of each part based on a key point recognition algorithm, so as to construct the line collision body based on the at least three key points.

7. The method according to claim 6, wherein the at least one part comprises at least one of a plurality of parts of a face and a plurality of parts of limbs and torso.

8. The method according to claim 1, wherein the main element is an eye part in a face; and
wherein the method further comprises: before stacking and displaying, in response to determining that the relative present information between the at least one first present element and the main element is the persistence presentation, the at least one first present element on the main element,
determining an absence of a first present element being stacked on the eye part, in response to determining that the eye part is in a closed state according to the key points of the eye part.

9. The method according to claim 5, wherein determining the relative present information between each first present element and the main element based on the collision body information and the current display information of each first present element comprises:
determining, for each first present element and according to position information of the current first present element, a distance value between the current first present element and the corresponding line segment in a normal vector direction of the corresponding collision line segment on the line collision body, and determining whether there is an intersection point between a projection point of the current first present element in the normal vector direction and the collision line segment, wherein the normal vector direction is determined according to key point information corresponding to the two endpoints of the collision line segment; and
in response to determining that the distance value is less than a preset collision distance threshold and there is the intersection point, determining that the relative present information between the current first present element and the corresponding line collision body is the persistence presentation.

10. The method according to claim 9, wherein displaying the at least one first present element on the main element comprises:
stacking the at least one first present element on the main element.

11. The method according to claim 9, further comprising:
determining, in response to determining that the distance value is greater than the preset collision distance threshold or there is an absence of the intersection point, that the relative present information between the current first present element and the corresponding line collision body is the non-persistence presentation;
wherein continuing to dynamically present, according to the preset present mode, the first present element having the relative present information with the main element being the non-persistence presentation comprises:
continuing to dynamically present, according to the preset present mode, the first present element in the non-persistence presentation on the display interface on the basis of a previous video frame.

12. The method according to claim 1, wherein the first present element comprises at least one of a snowflake element, a water droplet element, and a hail element.

13. The method according to claim 1, further comprising:
determining at least one first present element in the persistence presentation as at least one first present element to be processed; and
determining target velocity information of each first present element to be processed after colliding with the main element, such that display information for each first present element to be processed in a next video frame is determined based on the target velocity information, and relative present information between each first present element to be processed and the main element is determined based on the display information,
wherein the display information comprises display position information.

14. The method according to claim 13, wherein determining the target velocity information of each first present element to be processed after colliding with the main element comprises:
for each first present element to be processed, determining relative velocity information to be updated based on a movement velocity of a current first present element to be processed and an average movement velocity of a corresponding collision line segment in a line collision body, wherein the average movement velocity is determined according to position information of two endpoints of the collision line segment in a previous video frame and position information of the two endpoints of the collision line segment in a current video frame;
determining, based on the relative velocity information to be updated, a first projection component of the relative velocity information to be updated in a normal vector direction of the line collision body;
updating the relative velocity information to be updated based on the first projection component to obtain velocity information to be used of the current first present element to be processed; and
determining target velocity information of the current first present element to be processed according to the velocity information to be used and the average movement velocity of the line collision body.

15. The method according to claim 14, wherein updating the relative velocity information to be updated based on the first projection component to obtain the velocity information to be used of the current first present element to be processed comprises:
in response to determining that the first projection component is less than a preset projection component threshold, determining a second projection component of the relative velocity information to be updated in a tangent vector direction of the line collision body; and
in response to determining that the second projection component is less than a static friction critical velocity, determining the velocity information to be updated as a first preset relative velocity,
wherein the static friction critical velocity is determined based on the first projection component and a static friction coefficient.

16. The method according to claim 15, further comprising:
in response to determining that the second projection component is greater than the static friction critical velocity, updating the relative velocity information to be updated based on the static friction coefficient, the second projection component and the first projection component, to obtain the velocity information to be used.

17. The method according to claim 15, wherein updating the relative velocity information to be updated based on the first projection component to obtain velocity information to be updated of the current first present element to be processed comprises:
in response to determining that the first projection component is greater than the preset projection component threshold, determining the target processing method to use the relative velocity information as the velocity information to be updated.

18. The method according to claim 13, further comprising:
determining display information of the corresponding first present element to be processed in the next video frame according to the target velocity information of each first present element to be processed and normal vector gravity information of the belonging line collision body;
determining, based on the preset present mode, display information of each first present element in the non-stack display; and
determining, based on the display information, relative present information between each main element and each first present element in the next video frame.

19. (canceled)

20. An electronic device, wherein the electronic device comprises:
a processor; and
a storage means, configured to store a program, and
when the program is executed by the processor, the processor is caused to:
dynamically present, in response to an effect trigger operation, a plurality of first present elements according to a preset present mode;
display, in response to determining that relative present information between at least one first present element and a main element is a persistence presentation, the at least one first present element on the main element; and
continue to dynamically present, according to the preset present mode, a first present element having relative present information with the main element being a non-persistence presentation.

21. A non-transitory storage medium comprising computer executable instructions, wherein the computer executable instructions, when executed by a computer processor, are configured to:
dynamically present, in response to an effect trigger operation, a plurality of first present elements according to a preset present mode;
display, in response to determining that relative present information between at least one first present element and a main element is a persistence presentation, the at least one first present element on the main element; and
continue to dynamically present, according to the preset present mode, a first present element having relative present information with the main element being a non-persistence presentation.
